(19) United States
(12) Patent Application Publication
(10) Pub. No.: US 2024/0339252 A1
(43) Pub. Date: Oct. 10, 2024

(54) RARE EARTH SINTERED MAGNET, METHOD FOR PRODUCING RARE EARTH SINTERED MAGNET, ROTOR, AND ROTARY MACHINE

(71) Applicant: Mitsubishi Electric Corporation, Tokyo (JP)

(72) Inventors: Akito IWASAKI, Tokyo (JP); Yasutaka NAKAMURA, Tokyo (JP); Tatsuya KITANO, Tokyo (JP)

(73) Assignee: Mitsubishi Electric Corporation, Tokyo (JP)

(21) Appl. No.: 18/293,355

(22) PCT Filed: Aug. 4, 2021
(86) PCT No.: PCT/JP2021/028943

§ 371 Date: Jan. 30, 2024

(51) Int. Cl. H01F 1/057; B22F 3/16; B22F 3/24; B22F 9/04; C22C 38/00; H02K 1/02

(52) U.S. Cl. CPC H01F 1/0577; B22F 3/16; B22F 3/24; B22F 9/04; C22C 38/001; C22C 38/002; C22C 38/005; H02K 1/02; B22F 2003/248; B22F 2301/355; B22F 2998/10; B22F 2999/00; C22C 2200/00; C22C 2202/02

(57) ABSTRACT

The present disclosure provides a rare earth sintered magnet satisfying the general formula (Nd, La, Sm)—Fe—B-M, where the element M is one or more elements selected from the group consisting of Cu, Al, and Ga, the rare earth sintered magnet including: a main phase including crystal grains based on an R₂Fe₁₄B crystal structure; a first subphase that is crystalline and mainly composed of an oxide phase represented by (Nd, La, Sm)—O; and a second subphase that is crystalline and mainly composed of an oxide phase represented by (Nd, La)—O. The concentration of Sm is higher in the first subphase than in the second subphase, and the concentration of the element M is higher in the second subphase than in the first subphase.

### FIELD

The present disclosure relates to a rare earth sintered magnet which is a permanent magnet obtained by sintering a material containing a rare earth element, a method for producing a rare earth sintered magnet, a rotor, and a rotary machine.

### BACKGROUND

R-T-B-based permanent magnets having a tetragonal R₂T₁₄B intermetallic compound as a main phase are known. Here, the element R is a rare earth element, the element T is a transition metal element including Fe (iron) or Fe partially replaced by cobalt (Co), and B is boron. R-T-B-based permanent magnets are used for various high value-added components including industrial motors. In particular, Nd-Fe-B-based sintered magnets in which the element R is neodymium (Nd) are used for various components due to excellent magnetic properties. In addition, because industrial motors are often used in a high temperature environment exceeding 100° C., attempts have been made to improve coercive force by adding heavy rare earth elements such as dysprosium (Dy) to Nd-T-B-based permanent magnets.

In recent years, the production of Nd-Fe-B-based sintered magnets has been expanded, and the consumption of Nd and heavy rare earth elements such as Dy and terbium (Tb) has been increased. However, Nd and heavy rare earth elements are expensive and also have a procurement risk due to high distribution unevenness. In view of this, a possible measure for reducing the consumption of Nd and heavy rare earth elements is to use other rare earth elements as the element R, such as cerium (Ce), lanthanum (La), samarium (Sm), scandium (Sc), gadolinium (Gd), yttrium (Y), and lutetium (Lu). However, magnetic properties are known to be significantly degraded by substituting these elements for all or a part of Nd. Therefore, attempts have been conventionally made to develop technology that allows for prevention of degradation of magnetic properties associated with temperature rise in the case of using these elements for producing Nd-Fe-B-based sintered magnets.

For example, Patent Literature 1 discloses a rare earth magnet alloy including a main phase having a tetragonal R₂Fe₁₄B crystal structure and mainly composed of Fe, B, and one or more elements selected from the group consisting of Nd, La, and Sm, and a crystalline subphase mainly composed of oxygen (O) and one or more elements selected from the group consisting of Nd, La, and Sm. In the rare earth magnet alloy described in Patent Literature 1, La is segregated in the crystalline subphase, and Sm is dispersed without segregation in the main phase and the crystalline subphase. In the rare earth magnet alloy described in Patent Literature 1, the above-described structure form prevents degradation of magnetic properties associated with temperature rise.

Patent Literature 2 discloses a rare earth magnet including a first phase containing a compound represented by RₐT_{b}X, a grain boundary phase which is present at the crystal grain boundary of the first phase and has a higher concentration of the element R than RₐT_{b}X, and a second phase consisting of a single crystal of a compound represented by S_{c}M_{d}. Here, the element R is one or more rare earth elements including Nd, the element T is one or more transition metal elements including Fe, and the element X is one or more elements selected from B and carbon (C). The element S is one or more rare earth elements including Sm, and the element M is one or more transition metal elements including Co. According to the technique described in Patent Literature 2, a rare earth magnet having sufficient magnetic properties even at a high temperature is obtained.

Patent Literature 3 discloses an R-T-B-based sintered magnet including a first main phase composed of crystal grains of an R-T-B-based alloy containing a light rare earth element as the element R, a second main phase composed of crystal grains of an R-T-B-based alloy containing a heavy rare earth element as the element R, a surface phase surrounding the surfaces of the crystal grains constituting the first main phase and the second main phase, and a grain boundary alloy phase present at the grain boundary triple point. Here, the element T is Fe or Fe partially replaced by Co. In the R-T-B-based sintered magnet described in Patent Literature 3, the concentration of the heavy rare earth element is lower in the first main phase and the grain boundary alloy phase than that in the second main phase and the surface phase. According to the technique described in Patent Literature 3, the coercive force can be effectively improved using rare earth elements that give a high coercive force.

### CITATION LIST

### Patent Literature

Patent Literature 1: PCT Patent Application Laid-open No. 2021/048916

Patent Literature 2: Japanese Patent Application Laid-open No. 2021-9862

Patent Literature 3: Japanese Patent Application Laid-open No. 2018-174205

### SUMMARY OF INVENTION

### Problem to be Solved by the Invention

However, the rare earth magnet alloy described in Patent Literature 1, in which Sm is uniformly dispersed in the main phase and the subphase in the rare earth magnet alloy, can prevent degradation of magnetic properties associated with temperature rise, but may not contribute to improvement of magnetic properties at room temperature. In addition, in the rare earth magnet described in Patent Literature 2, the second phase is composed of a single crystal, and the elements present in the second phase do not differ in concentration. That is, the second phases distributed in the rare earth magnet have the same composition at any positions, and are formed of one kind of compound having a uniform concentration distribution. For this reason, the rare earth magnet described in Patent Literature 2 does not have an optimal structure for improvement of magnetic properties at room temperature. In short, the problem is that there is room for further improvement in magnetic properties. In addition, the R-T-B-based sintered magnet described in Patent Literature 3 is configured to always contain a heavy rare earth element, which results in a high coercive force. However, there is a problem in that the residual magnetic flux density required for industrial motors or the like cannot be obtained, which leads to degradation of magnetic properties. Thus, there has been a demand for a rare earth sintered magnet that achieves both improvement of magnetic properties at room temperature and prevention of degradation of magnetic properties associated with temperature rise.

The present disclosure has been made in view of the above, and an object thereof is to obtain a rare earth sintered magnet capable of improving magnetic properties at room temperature and preventing degradation of magnetic properties associated with temperature rise with reduced use of Nd and heavy rare earth elements.

### Means to Solve the Problem

To solve the problems above and achieve an object, the present disclosure is directed to a rare earth sintered magnet satisfying a general formula (Nd, La, Sm)—Fe—B-M, where element M is one or more elements selected from a group consisting of Cu, Al, and Ga, the rare earth sintered magnet including: a main phase including crystal grains based on an R₂Fe₁₄B crystal structure; a first subphase that is crystalline and mainly composed of an oxide phase represented by (Nd, La, Sm)—O; and a second subphase that is crystalline and mainly composed of an oxide phase represented by (Nd, La)—O. A concentration of Sm is higher in the first subphase than in the second subphase, and a concentration of the element M is higher in the second subphase than in the first subphase.

### Effects of the Invention

The present disclosure can achieve the effect of improving magnetic properties at room temperature and preventing degradation of magnetic properties associated with temperature rise with reduced use of Nd and heavy rare earth elements.

### BRIEF DESCRIPTION OF DRAWINGS

FIG. 1 is a diagram schematically illustrating an exemplary sintered structure of a rare earth sintered magnet according to a first embodiment.

FIG. 2 is a diagram illustrating atomic sites in a tetragonal Nd₂Fe₁₄B crystal structure.

FIG. 3 is a flowchart illustrating an exemplary procedure of a method for producing a rare earth magnet alloy according to a second embodiment.

FIG. 4 is a diagram schematically illustrating the method for producing a rare earth magnet alloy according to the second embodiment.

FIG. 5 is a flowchart illustrating an exemplary procedure of a method for producing a rare earth sintered magnet according to the second embodiment.

FIG. 6 is a cross-sectional view schematically illustrating an exemplary configuration of a rotor equipped with a rare earth sintered magnet according to a third embodiment.

FIG. 7 is a cross-sectional view schematically illustrating an exemplary configuration of a rotary machine according to a fourth embodiment.

FIG. 8 is a composition image obtained by analyzing a cross section of a rare earth sintered magnet according to Examples 1 to 8 with FE-EPMA.

FIG. 9 is an element map of Nd obtained by analyzing a cross section of a rare earth sintered magnet according to Examples 1 to 8 with FE-EPMA.

FIG. 10 is an element map of O obtained by analyzing a cross section of a rare earth sintered magnet according to Examples 1 to 8 with FE-EPMA.

FIG. 11 is an element map of La obtained by analyzing a cross section of a rare earth sintered magnet according to Examples 1 to 8 with FE-EPMA.

FIG. 12 is an element map of Sm obtained by analyzing a cross section of a rare earth sintered magnet according to Examples 1 to 8 with FE-EPMA.

FIG. 13 is an element map of Cu obtained by analyzing a cross section of a rare earth sintered magnet according to Examples 1 to 8 with FE-EPMA.

FIG. 14 is an element map of Al obtained by analyzing a cross section of a rare earth sintered magnet according to Examples 1 to 8 with FE-EPMA.

FIG. 15 is an element map of Ga obtained by analyzing a cross section of a rare earth sintered magnet according to Examples 1 to 8 with FE-EPMA.

### DESCRIPTION OF EMBODIMENTS

Hereinafter, a rare earth sintered magnet, a method for producing a rare earth sintered magnet, a rotor, and a rotary machine according to embodiments of the present disclosure will be described in detail with reference to the drawings.

### First Embodiment

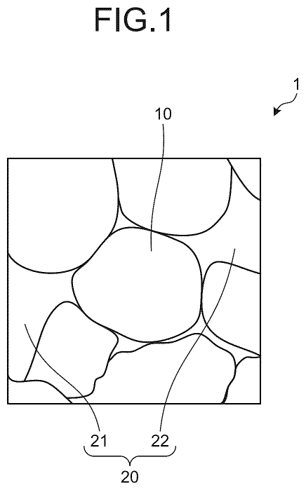

FIG. 1 is a diagram schematically illustrating an exemplary sintered structure of a rare earth sintered magnet according to the first embodiment. The permanent magnet according to the first embodiment is a rare earth sintered magnet 1 satisfying the general formula (Nd, La, Sm)—Fe—B-M, and including a main phase 10 including crystal grains based on an R₂Fe₁₄B crystal structure and a subphase 20. The subphase 20 includes a first subphase 21 that is crystalline and mainly composed of an oxide phase represented by (Nd, La, Sm)—O, and a second subphase 22 that is crystalline and mainly composed of an oxide phase represented by (Nd, La)—O. The element M indicates one or more elements selected from the group consisting of copper (Cu), aluminum (Al), and gallium (Ga).

The main phase 10 has a tetragonal R₂Fe₁₄B crystal structure in which the element R is Nd, La, and Sm. That is, the main phase 10 has the composition formula (Nd, La, Sm)₂Fe₁₄B. The reason why the element R of the rare earth sintered magnet 1 having a tetragonal R₂Fe₁₄B crystal structure is rare earth elements consisting of Nd, La, and Sm is from the calculation of magnetic interaction energy with the use of a molecular orbital method. The calculation shows that a composition in which La and Sm are added to Nd can produce the rare earth sintered magnet 1 which is practical in that degradation of magnetic properties associated with temperature rise can be prevented. In addition, by intentionally segregating La and Sm also in the grain boundary that is an example of the subphase 20, it is possible to make Nd relatively diffused throughout the main phase 10 so that magnetocrystalline anisotropy of the main phase 10 is enhanced. Consequently, a pseudo core-shell structure is formed in which a portion having high magnetic anisotropy and a portion having low magnetic anisotropy exist in the main phase 10. As a result, the effect of preventing degradation of magnetic properties associated with temperature rise is further enhanced.

Note that when too much La and Sm are added, it causes a decrease in the amount of Nd, which is an element having a high magnetic anisotropy constant and a high saturation magnetic polarization, which results in degradation of magnetic properties. Therefore, it is preferable to satisfy a>(b+c), where a, b, and c represent the composition ratios of Nd, La, and Sm, respectively.

The average grain size of the crystal grains of the main phase 10 is preferably 100 μm or less, and more preferably 0.1 μm to 50 μm for improving magnetic properties.

The crystalline subphase 20 is a generic term for the first subphase 21 and the second subphase 22 that are crystalline, and is present between the main phases 10. The crystalline first subphase 21 is represented by (Nd, La, Sm)—O as described above, and the crystalline second subphase 22 is represented by (Nd, La)—O as described above. Here, (Nd, La, Sm)—O means that a part of Nd is replaced by La and Sm. Note that the elements of the main components are described in parentheses; therefore, the first subphase 21 and the second subphase 22 may contain a small amount of another component. In one example, the second subphase 22 represented by (Nd, La)—O contains an extremely small amount of Sm.

In the rare earth sintered magnet 1 according to the first embodiment, the concentration of Sm is higher in the first subphase 21 than in the second subphase 22, and the concentration of the element M is higher in the second subphase 22 than in the first subphase 21. In other words, it means that Sm and the element M are segregated in different subphases 20. Sm is present at a higher concentration in the first subphase 21. Thus, Nd in the Nd-rich phase is relatively diffused throughout the main phase 10, which results in improved magnetocrystalline anisotropy of the main phase 10. Furthermore, Sm also exists in the crystal grains of the main phase 10, and thus contributes to improvement of the residual magnetic flux density by being coupled in the same magnetization direction with Fe, a ferromagnetic substance. The element M is present at a high concentration in the second subphase 22. Thus, the element M forms a nonmagnetic phase that magnetically separates the main phases 10 from each other, and contributes to improvement of magnetic properties. Because Sm and the element M are present at a high concentration in the different subphases 20, it is possible to improve both the residual magnetic flux density and the coercive force.

In the rare earth sintered magnet 1 according to the first embodiment, the concentrations of La and Sm differ between the main phase 10 and the subphase 20: the sum of the concentrations of La in the first subphase 21 and the second subphase 22 is equal to or greater than the concentration of La in the main phase 10, and the sum of the concentrations of Sm in the first subphase 21 and the second subphase 22 is equal to or greater than the concentration of Sm in the main phase 10. Specifically, the concentrations of La and Sm in the subphase 20 are equal to or higher than the concentrations of La and Sm in the main phase 10. Furthermore, the concentration of La also differs between the first subphase 21 and the second subphase 22: the concentration of La in the first subphase 21 is equal to or higher than the concentration of La in the second subphase 22.

Here, given that X represents the concentration of La contained in the main phase 10, X₁ represents the concentration of La contained in the first subphase 21, X₂ represents the concentration of La contained in the second subphase 22, Y represents the concentration of Sm contained in the main phase 10, Y₁ represents the concentration of Sm contained in the first subphase 21, and Y₂ represents the concentration of Sm contained in the second subphase 22, the relationship of Formula (1) below is satisfied.

$$1 < ( {Y}_{1} + {Y}_{2} ) / Y < ( {X}_{1} + {X}_{2} ) / X \qquad ( 1 )$$

La is present at a high concentration in the grain boundary in the process of production, particularly in the heat treatment, whereby Nd is relatively diffused throughout the main phase 10. As a result, in the rare earth sintered magnet 1 according to the first embodiment, Nd in the main phase 10 is not consumed at the grain boundary, which leads to improve magnetocrystalline anisotropy. Sm is also present at a higher concentration in the subphase 20, particularly in the first subphase 21, than in the main phase 10. Thus, Nd is relatively diffused throughout the main phase 10 as in the case of La, resulting in improved magnetocrystalline anisotropy.

The rare earth sintered magnet 1 according to the first embodiment may contain an additive element N that improves magnetic properties. The additive element N is one or more elements selected from the group consisting of Co, zirconium (Zr), titanium (Ti), praseodymium (Pr), niobium (Nb), Dy, Tb, manganese (Mn), Gd, and holmium (Ho).

Therefore, the rare earth sintered magnet 1 according to the first embodiment is expressed by the general formula (NdₐLa_{b}Sm_{c})Fe_{d}BₑM_{f}N_{g}, where the additive element N is one or more elements selected from the group consisting of Co, Zr, Ti, Pr, Nb, Dy, Tb, Mn, Gd, and Ho. It is desirable that a, b, c, d, e, f, and g satisfy the following relational expressions.

$$5 \leq a \leq 20 \\ 0 < b + c < a \\ 70 \leq d \leq 90 \\ 0.5 \leq e \leq 10 \\ 0 \leq f \leq 5 \\ 0 \leq g \leq 5 \\ a + b + c + d + e + f + g = 100 atom \%$$

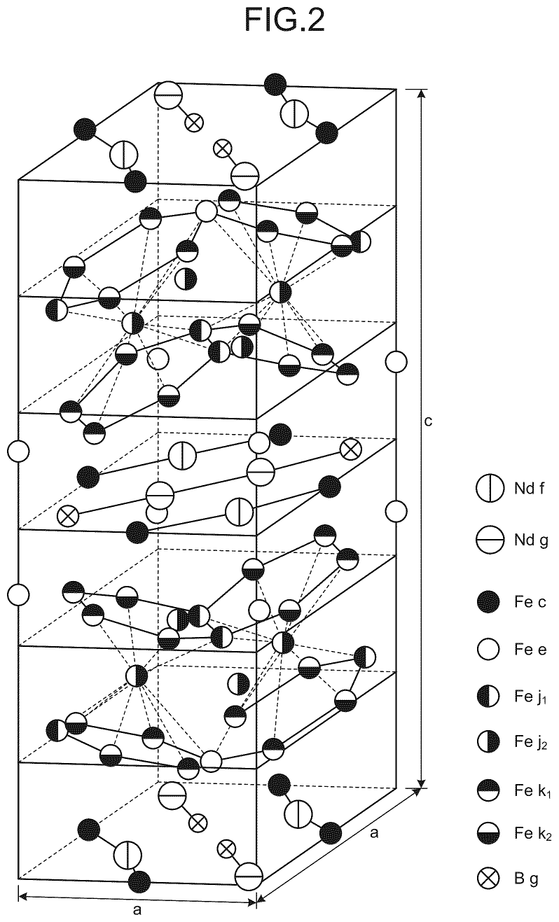

Next, at which atomic sites of the tetragonal R₂Fe₁₄B crystal structure La and Sm are substituted will be described. FIG. 2 is a diagram illustrating atomic sites in a tetragonal Nd₂Fe₁₄B crystal structure. Note that the crystal structure illustrated in FIG. 2 is described, for example, in FIG. 1 of Reference Literature 1 shown below. The sites of substitution are determined from the numerical value of the stabilization energy associated with substitution computed using band calculation and molecular field approximation based on the Heisenberg model.

(Reference Literature 1) J. F. Herbst et al. “Relationships between crystal structure and magnetic properties in Nd₂Fe₁₄B”. PHYSICAL REVIEW B. 1984, Vol. 29, No. 7, p. 4176-4178.

First, a method for calculating stabilization energy for La will be described. The stabilization energy for La can be computed as the energy difference between (Nd₇La₁)Fe₅₆B₄+Nd and Nd₈(Fe₅₅La₁)B₄+Fe using Nd₈Fe₅₆B₄ crystal cells. The smaller the energy value, the more stable it is when the atom is substituted at that site. That is, La is likely to be substituted at an atomic site having the smallest energy among the atomic sites. This calculation assumes that substituting La for the original atom does not change the lattice constant in the tetragonal R₂Fe₁₄B crystal structure due to the difference in atomic radius. Table 1 shows the stabilization energy for La at each substitution site at various environmental temperatures.

TABLE 1

| Substitu- | | | | | | |
|---|---|---|---|---|---|---|
| tion site | Temperature | | | | | |
| for La | 293 K | 500 K | 1000 K | 1300 K | 1400 K | 1500 K |
| Nd(f) | −136.372 | −84.943 | −48.524 | −40.132 | −38.132 | −35.451 |
| Nd(g) | −132.613 | −82.740 | −47.442 | −38.211 | −36.358 | −34.753 |
| Fe(k1) | −135.939 | −80.596 | −41.428 | −32.390 | −30.237 | −17.095 |
| Fe(k2) | −127.480 | −75.638 | −38.948 | −30.482 | −28.466 | −26.719 |
| Fe(j1) | −124.248 | −73.076 | −38.003 | −29.754 | −27.791 | −26.089 |
| Fe(j2) | −117.148 | −71.400 | −35.923 | −28.816 | −26.917 | −25.271 |
| Fe(e) | −130.814 | −77.593 | −39.926 | −31.235 | −29.164 | −27.371 |
| Fe(c) | −148.317 | −87.850 | −45.055 | −35.179 | −32.828 | −30.789 |

Unit: eV

Table 1 indicates that stable substitution sites for La are Nd (f) sites at temperatures of 1000K and higher, and Fe (c) sites at temperatures of 293K and 500K. As will be described later, the raw material of the rare earth sintered magnet 1 according to the first embodiment is heated and melted at a temperature of 1000K or higher and then rapidly cooled. Therefore, it is considered that the raw material of the rare earth sintered magnet 1 is maintained in a state of 1000K or higher, that is, 727° C. or higher, and more preferably about 1300K, that is, 1027° C. In this case, La is considered to be substituted at Nd (f) sites or Nd (g) sites. Here, La is considered to be preferentially substituted at energetically stable Nd (f) sites, but may be substituted at Nd (g) sites having a small energy difference among the substitution sites for La. This is why Nd (g) sites are mentioned as a candidate for the substitution sites for La.

Furthermore, when the rare earth sintered magnet 1 is produced with the production method described later, the temperature is 1000K or higher at the time of sintering, but the Fe (c) sites described in Table 1 are held in an energetically stable temperature zone through the primary aging step, the secondary aging step, and the cooling step. In other words, the substitution of La at Nd sites of the main phase 10 is maintained in an unstable energy state. That is, La is mainly substituted at Nd sites of the main phase 10 when the rare earth sintered magnet 1 is in the stage of raw material; however, it can be said that La is segregated in the subphase 20 in the rare earth sintered magnet 1 that is produced with the production method described later. This is a consequence of intentionally holding the Nd sites of the main phase 10 in a temperature region in an unstable energy state, a certain amount of La is released from the Nd sites of the main phase 10.

Next, a method for calculating stabilization energy in Sm will be described. The stabilization energy of Sm can be computed as the energy difference between (Nd₇Sm₁)Fe₅₆B₄+Nd and Nd₈(Fe₅₅Sm₁)B₄+Fe. As with the case of La, atomic substitution does not change the lattice constant in the tetragonal R₂Fe₁₄B crystal structure. Table 2 shows the stabilization energy of Sm at each substitution site at various environmental temperatures.

TABLE 2

| Substitu- | | | | | | |
|---|---|---|---|---|---|---|
| tion site | Temperature | | | | | |
| for Sm | 293 K | 500 K | 1000 K | 1300 K | 1400 K | 1500 K |
| Nd(f) | −164.960 | −101.695 | −56.921 | −46.589 | −44.128 | −41.976 |
| Nd(g) | −168.180 | −103.583 | −57.865 | −47.315 | −44.803 | −42.626 |
| Fe(k1) | −136.797 | −81.098 | −41.679 | −32.583 | −17.350 | −16.343 |
| Fe(k2) | −127.769 | −75.808 | −38.482 | −29.603 | −28.528 | −25.696 |
| Fe(j1) | −122.726 | −73.304 | −37.783 | −28.392 | −26.525 | −24.681 |
| Fe(j2) | −124.483 | −73.883 | −38.072 | −28.483 | −26.610 | −24.985 |
| Fe(e) | 125.937 | 72.525 | 35.301 | 26.633 | 24.450 | 22.782 |
| Fe(c) | −155.804 | −94.457 | −48.359 | −37.720 | −35.187 | −32.992 |

Unit: eV

Table 2 indicates that stable substitution sites for Sm are Nd (g) sites at any temperature, unlike in the case of La. Sm is also considered to be preferentially substituted at energetically stable Nd (g) sites, but may be substituted at Nd (f) sites having a small energy difference among the substitution sites for Sm.

When the rare earth sintered magnet 1 is produced with the production method described later, substitution at Nd (g) sites of the main phase 10 is most stable in terms of energy. However, as described above, holding in a temperature range where the substitution of La at Nd sites of the main phase 10 is unstable causes a part of Sm to be released from the Nd sites of the main phase 10 together with La and segregated in the subphase 20. As a result, the concentrations of La and Sm differ between the main phase 10 and the subphase 20: the sum of the concentrations of La in the first subphase 21 and the second subphase 22 is equal to or greater than the concentration of La in the main phase 10, and the sum of the concentrations of Sm in the first subphase 21 and the second subphase 22 is equal to or greater than the concentration of Sm in the main phase 10. That is, La and Sm can be said to be segregated in the subphase 20. Furthermore, because La is segregated in the subphase 20 together with Sm, it can be said that the concentration of La in the first subphase 21 is equal to or higher than the concentration of La in the second subphase 22, as in the case of the concentration of Sm.

In addition, comparing La and Sm, La held in a temperature range in an unstable energy state is overwhelmingly more likely to be segregated in the subphase 20 from the viewpoint of energy. As a result, in the case of the rare earth sintered magnet 1 that is prepared with almost the same concentrations of La and Sm, La and Sm present in the rare earth sintered magnet 1 satisfy the relationship of Formula (1) above: La has a larger segregation ratio to the subphase 20.

Furthermore, the element M such as Cu, Al, and Ga that forms a nonmagnetic phase at the grain boundary and contributes to high coercive force is also originally present in the subphase 20. However, as described above, through the aging step and the cooling step, La and Sm are segregated in similar subphases 20, and as a result, the element M is mainly present in the subphase 20 that is different from the subphases in which La and Sm are segregated. That is, each element is not uniformly present, but the concentration of the element M including Cu, Al, and Ga is higher in the second subphase 22 than in the first subphase 21. This produces the rare earth sintered magnet 1 characterized in that the concentration of Sm is higher in the first subphase 21 than in the second subphase 22, the concentration of the element M is higher in the second subphase 22 than in the first subphase 21, and the concentrations of Sm and the element M are high in different types of subphases 20 to each other.

As described above, the rare earth sintered magnet 1 according to the first embodiment satisfies the general formula (Nd, La, Sm)—Fe—B-M, where the element M is one or more elements selected from the group consisting of Cu, Al, and Ga, the rare earth sintered magnet 1 including: the main phase 10 including crystal grains based on an R₂Fe₁₄B crystal structure; the first subphase 21 that is crystalline and mainly composed of an oxide phase represented by (Nd, La, Sm)—O; and the second subphase 22 that is crystalline and mainly composed of an oxide phase represented by (Nd, La)—O. In the rare earth sintered magnet 1 according to the first embodiment, the concentration of Sm is higher in the first subphase 21 than in the second subphase 22, and the concentration of the element M is higher in the second subphase 22 than in the first subphase 21. That is, the concentration of Sm and the concentration of the element M in the subphase 20 differ. Consequently, Sm, which is present at a higher concentration in the first subphase 21, makes Nd relatively diffused throughout the main phase 10, resulting in improved magnetocrystalline anisotropy of the main phase 10. Furthermore, Sm also exists in the crystal grains of the main phase 10, and thus contributes to improvement of the residual magnetic flux density by being coupled in the same magnetization direction with Fe, which is a ferromagnetic substance. The element M, which is present at a high concentration in the second subphase 22, forms a nonmagnetic phase that magnetically separates the main phases 10 from each other, contributing to improvement of magnetic properties. Because Sm and the element M are present at high concentrations in the different subphases 20, it is possible to improve both the residual magnetic flux density and the coercive force.

Furthermore, because the main phase 10 has a tetragonal R₂Fe₁₄B crystal structure in which the element R is Nd, La, and Sm, the rare earth sintered magnet 1 can reduce or prevent degradation of magnetic properties associated with temperature rise. As a result, it is possible to obtain the rare earth sintered magnet 1 capable of improving magnetic properties at room temperature and reducing or preventing degradation of magnetic properties associated with temperature rise while use of Nd and heavy rare earth elements are reduced compared with the rare earth sintered magnet satisfying Nd—Fe—B.

### Second Embodiment

In the second embodiment, a method for producing the rare earth sintered magnet 1 described in the first embodiment will be described separately as for a method for producing a rare earth magnet alloy that is the raw material of the rare earth sintered magnet 1 and for a method for producing the rare earth sintered magnet 1 using the rare earth magnet alloy.

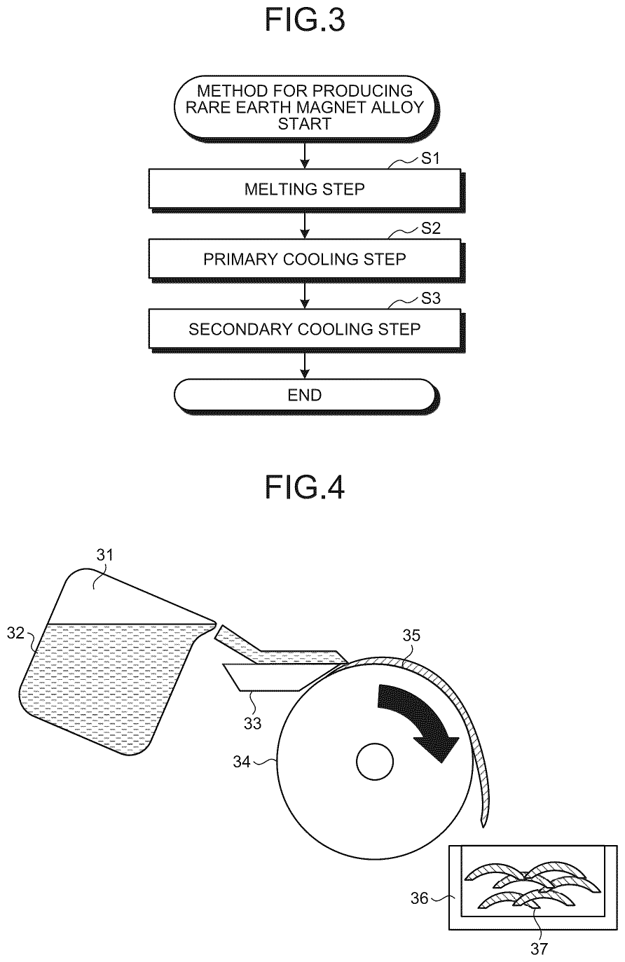

FIG. 3 is a flowchart illustrating an exemplary procedure of a method for producing a rare earth magnet alloy according to the second embodiment. FIG. 4 is a diagram schematically illustrating the method for producing a rare earth magnet alloy according to the second embodiment.

First, as illustrated in FIG. 3, the method for producing a rare earth magnet alloy includes a melting step (step S1) of heating and melting the raw material of the rare earth magnet alloy containing an element constituting the rare earth sintered magnet 1 at a temperature of 1000K or higher, a primary cooling step (step S2) of cooling the molten raw material on a rotating body to obtain a solidified alloy, and a secondary cooling step (step S3) of further cooling the solidified alloy in a container. Each step will be described below.

In the melting step S1, as illustrated in FIG. 4, the raw material of the rare earth magnet alloy is heated and melted at a temperature of 1000K or higher in a crucible 31 in an atmosphere containing an inert gas such as argon (Ar) or in a vacuum. Consequently, the rare earth magnet alloy melts into a molten alloy 32. The raw material can be a combination of Nd, La, Sm, Fe, B, and one or more elements M selected from the group consisting of Al, Cu, and Ga. At this time, as the additive element N, one or more elements selected from the group consisting of Co, Zr, Ti, Pr, Nb, Dy, Tb, Mn, Gd, and Ho may be contained in the raw material.

Next, in the primary cooling step S2, as illustrated in FIG. 4, the molten alloy 32 prepared in the melting step is fed to a tundish 33, and subsequently fed onto a single roll 34 which is a rotating body rotating in the direction of the arrow. Consequently, the molten alloy 32 is rapidly cooled on the single roll 34, and a solidified alloy 35 that is thinner than the ingot alloy is prepared on the single roll 34 from the molten alloy 32. In this example, the single roll 34 is used as the rotating body, but the present disclosure is not limited thereto, and twin rolls, a rotating disk, a rotating cylindrical mold, or the like may be used for rapid contact cooling. From the viewpoint of efficiently obtaining the thin solidified alloy 35, the cooling rate in the primary cooling step is preferably in the range of 10° C./s to 10⁷° C./s, and more preferably in the range of 10³° C./s to 10⁴° C./s. The thickness of the solidified alloy 35 is in the range of 0.03 mm to 10 mm. The molten alloy 32 starts to be solidified at the portion in contact with the single roll 34, and crystals grow in a columnar or needle shape in the thickness direction from the surface of contact with the single roll 34.

Thereafter, in the secondary cooling step S3, as illustrated in FIG. 4, the thin solidified alloy 35 prepared in the primary cooling step is placed in a tray container 36 and cooled. When entering the tray container 36, the thin solidified alloy 35 is crushed into scale-shaped pieces of rare earth magnet alloy 37 and cooled. Depending on the cooling rate, ribbon-shaped pieces of rare earth magnet alloy 37 may be obtained, instead of scale-shaped pieces. From the viewpoint of obtaining the rare earth magnet alloy 37 having a structure with favorable temperature properties of magnetic properties, the cooling rate in the secondary cooling step is preferably in the range of 10⁻²° C./s to 10⁵° C./s, and more preferably in the range of 10⁻¹° C./s to 10²° C./s.

The rare earth magnet alloy 37 obtained through these steps has a fine crystal structure containing a (Nd, La, Sm)—Fe—B crystal phase having a minor-axis size of 3 μm to 10 μm and a major-axis size of 10 μm to 300 μm, and the crystalline oxide subphase 20 represented by (Nd, La, Sm)—O. Hereinafter, the crystalline oxide subphase 20 represented by (Nd, La, Sm)—O is referred to as the (Nd, La, Sm)—O phase. The (Nd, La, Sm)—O phase is a nonmagnetic phase consisting of an oxide having a relatively high concentration of rare earth elements. The thickness of the (Nd, La, Sm)—O phase is 10 μm or less, corresponding to the width of the grain boundary. Having undergone the step of rapid cooling, the rare earth magnet alloy 37 produced with the above production method has a refined structure and a small crystal grain size compared with the rare earth magnet alloy obtained with mold casting.

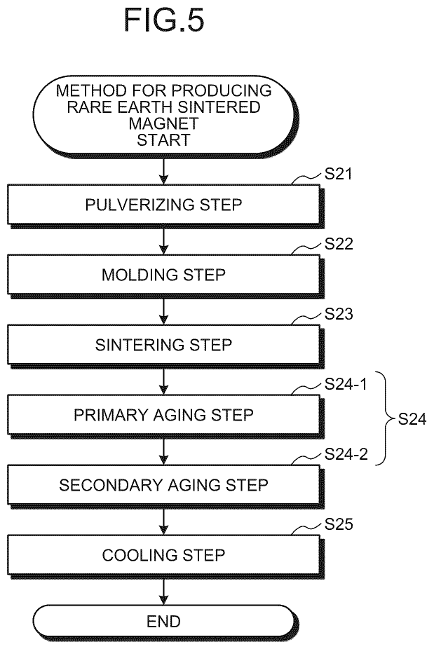

FIG. 5 is a flowchart illustrating an exemplary procedure of a method for producing a rare earth sintered magnet according to the second embodiment. As illustrated in FIG. 5, the method for producing the rare earth sintered magnet 1 includes a pulverizing step (step S21) of pulverizing the rare earth magnet alloy 37 satisfying (Nd, La, Sm)—Fe—B-M, a molding step (step S22) of preparing a molded body by molding the pulverized rare earth magnet alloy 37, a sintering step (step S23) of obtaining a sintered body by sintering the molded body, an aging step (step S24) of aging the sintered body, and a cooling step (step S25) of cooling the aged sintered body.

In the pulverizing step S21, the rare earth magnet alloy 37 produced with the method for producing the rare earth magnet alloy 37 in FIG. 3, that is, the rare earth magnet alloy 37 having the (Nd, La, Sm)—Fe—B crystal phase and the (Nd, La, Sm)—O phase, is pulverized into rare earth magnet alloy powder having a grain size of 200 μm or less, preferably in the range of 0.5 μm to 100 μm. Note that the rare earth magnet alloy 37 pulverized here contains one or more elements M selected from the group consisting of Al, Cu, and Ga as described above. The pulverization of the rare earth magnet alloy 37 is performed using, for example, an agate mortar, a stamp mill, a jaw crusher, or a jet mill. In particular, for reducing the grain size of the powder, it is preferable to pulverize the rare earth magnet alloy 37 in an atmosphere containing an inert gas. By pulverizing the rare earth magnet alloy 37 in an atmosphere containing an inert gas, it is possible to reduce or prevent oxygen from being mixed into the powder. However, unless the pulverization atmosphere affects the magnetic properties of the magnet, the rare earth magnet alloy 37 may be pulverized in the air.

In the molding step S22, the powder of the rare earth magnet alloy 37 is compression-molded in a mold under a magnetic field to prepare a molded body. Here, the applied magnetic field can be 2 T in one example. Note that the molding may be performed not in a magnetic field but without applying a magnetic field.

In the sintering step S23, the molded body generated by compression molding is held at a sintering temperature in the range of 900° C. to 1300° C. for a period of time in the range of 0.1 hours to 10 hours, whereby a sintered body is prepared. The sintering is preferably performed in an atmosphere containing an inert gas or in a vacuum in order to reduce or prevent oxidation. The sintering may be performed while applying a magnetic field. In addition, the sintering step may additionally include a step of hot working or aging treatment in order to improve magnetic properties, that is, to induce magnetic field anisotropy or to improve coercive force. The sintering step may further include a step of infiltrating a compound containing Cu, Al, a heavy rare earth element, and the like into the crystal grain boundary, i.e. the boundary between the main phases 10.

The aging step in step S24 includes the primary aging step in step S24-1 and the secondary aging step in step S24-2. The condition of the primary aging step in step S24-1 is that the sintered body is held at a primary aging temperature that is a temperature lower than the sintering temperature, specifically, at a temperature of 700° C. or higher but lower than 900° C., for 0.1 hours to 10 hours.

The condition of the secondary aging step in step S24-2 is that the sintered body is held at a secondary aging temperature that is a temperature lower than the primary aging temperature, specifically, at a temperature of 450° C. or higher but lower than 700° C., for 0.1 hours to 10 hours.

In the cooling step in step S25, the sintered body is held at a temperature lower than the secondary aging temperature, specifically, at a temperature of 200° C. or higher but lower than 450° C., for 0.1 hours to 5 hours. Thereafter, the rare earth sintered magnet 1 is cooled to room temperature and completed.

By controlling the temperature and time in the sintering step, the aging step, and the cooling step as described above, it is possible to produce the rare earth sintered magnet 1 in which the concentration of Sm is higher in the first subphase 21 than in the second subphase 22, and the concentration of one or more elements M selected from the group consisting of Cu, Al, and Ga is higher in the second subphase 22 than in the first subphase 21. That is, in the aging step and the cooling step, the crystalline first subphase 21 mainly composed of an oxide phase represented by (Nd, La, Sm)—O and the crystalline second subphase 22 mainly composed of an oxide phase represented by (Nd, La)—O are generated from the (Nd, La, Sm)—O phase, according to the concentration of the element M in one example. Note that the second subphase 22 may contain a small amount of Sm.

In the second embodiment, the rare earth magnet alloy 37 having the (Nd, La, Sm)—Fe—B crystal phase and the (Nd, La, Sm)—O phase is pulverized into rare earth magnet alloy powder, which is then molded. Thereafter, the molded body is sintered to form a sintered body, and the sintered body is aged and cooled to become the rare earth sintered magnet 1. The rare earth sintered magnet 1 according to the first embodiment can thus be produced. In addition, in the primary aging step, the sintered body is held at a temperature lower than the sintering temperature, specifically, at a primary aging temperature of 700° C. or higher but lower than 900° C., for 0.1 hours to 10 hours. In the secondary aging step after the primary aging step, the sintered body is held at a secondary aging temperature lower than the primary aging temperature, specifically, at a temperature of 450° C. or higher but lower than 700° C., for 0.1 hours to 10 hours. In the cooling step, the sintered body is held at a temperature lower than the secondary aging temperature, specifically, at a temperature of 200° C. or higher but lower than 450° C., for 0.1 hours to 5 hours, and cooled to room temperature. Consequently, it is possible to produce the rare earth sintered magnet 1 in which the concentration of Sm is higher in the first subphase 21 than in the second subphase 22, and the concentration of one or more elements M selected from the group consisting of Cu, Al, and Ga is higher in the second subphase 22 than in the first subphase 21.

Furthermore, with the above-described production steps, it is possible to produce the rare earth sintered magnet 1 in which the sum of the concentrations of La in the first subphase 21 and the second subphase 22 is equal to or greater than the concentration of La in the main phase 10, the sum of the concentrations of Sm in the first subphase 21 and the second subphase 22 is equal to or greater than the concentration of Sm in the main phase 10, and the concentration of La in the first subphase 21 is equal to or higher than the concentration of La in the second subphase 22. In addition, it is possible to produce the rare earth sintered magnet 1 in which the concentration of La and the concentration of Sm contained in the main phase 10, the concentration of La and the concentration of Sm contained in the first subphase 21, and the concentration of La and the concentration of Sm contained in the second subphase 22 satisfy Formula (1) above.

### Third Embodiment

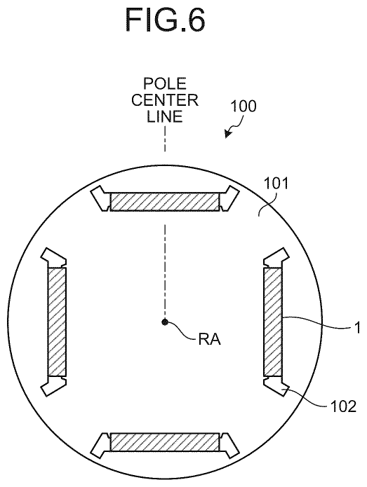

Next, a rotor equipped with the rare earth sintered magnet 1 according to the first embodiment will be described. FIG. 6 is a cross-sectional view schematically illustrating an exemplary configuration of a rotor equipped with a rare earth sintered magnet according to the third embodiment. FIG. 6 depicts a cross section in a direction perpendicular to a rotation axis RA of a rotor 100.

The rotor 100 is rotatable about the rotation axis RA. The rotor 100 includes a rotor core 101 and the rare earth sintered magnet 1 inserted into a magnet insertion hole 102 provided in the rotor core 101 along the circumferential direction of the rotor 100. In FIG. 6, four rare earth sintered magnets 1 are used, but the number of rare earth sintered magnets 1 is not limited thereto, and may be changed according to the design of the rotor 100. In addition, FIG. 6 illustrates an example in which the four magnet insertion holes 102 are provided in the rotor core 101 and the four rare earth sintered magnets 1 are inserted into the magnet insertion holes 102, but the number of magnet insertion holes 102 and number of the rare earth sintered magnets 1 may be changed according to the design of the rotor 100. The rotor core 101 is formed by a plurality of disk-shaped electromagnetic steel sheets stacked in the axial direction of the rotation axis RA.

The rare earth sintered magnets 1 have the structure described in the first embodiment and are produced with the production method described in the second embodiment. Each of the four rare earth sintered magnets 1 is inserted into the corresponding magnet insertion hole 102. The four rare earth sintered magnets 1 are magnetized such that the magnetic poles of the rare earth sintered magnets 1 on the radially outer side of the rotor 100 differ between adjacent rare earth sintered magnets 1.

As described above, the rotor 100 according to the third embodiment includes the rare earth sintered magnet 1 according to the first embodiment capable of improving magnetic properties at room temperature and reducing or preventing degradation of magnetic properties associated with temperature rise. Thus, because of the rare earth sintered magnet 1 capable of reducing or preventing degradation of magnetic properties associated with temperature rise while maintaining high residual magnetic flux density and coercive force, degradation of magnetic properties is reduced or prevented even in a high temperature environment exceeding 100° C. As a result, the operation of the rotor 100 can be stabilized even in a high temperature environment exceeding 100° C.

### Fourth Embodiment

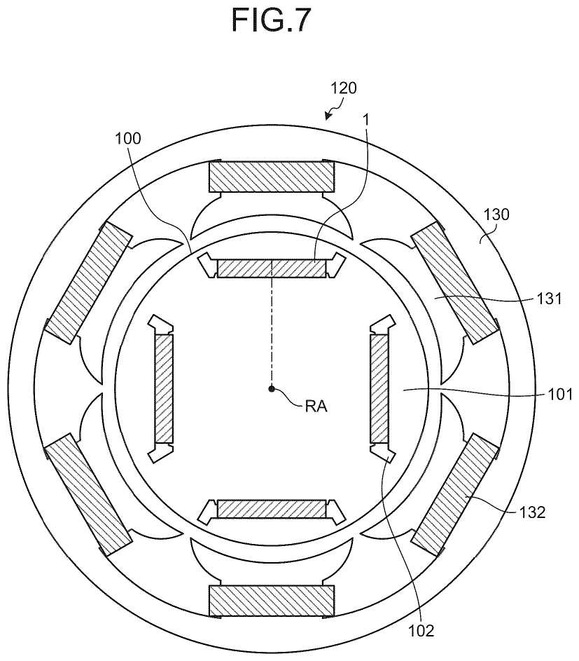

Next, a rotary machine equipped with the rotor 100 according to the fourth embodiment will be described. FIG. 7 is a cross-sectional view schematically illustrating an exemplary configuration of a rotary machine according to the fourth embodiment. FIG. 7 depicts a cross section in a direction perpendicular to the rotation axis RA of the rotor 100.

The rotary machine 120 includes the rotor 100 described in the third embodiment, which is rotatable about the rotation axis RA, and an annular stator 130 provided coaxially with the rotor 100 and facing the rotor 100. The stator 130 is formed by a plurality of electromagnetic steel sheets stacked in the axial direction of the rotation axis RA. Another existing configuration can be adopted as the configuration of the stator 130, instead of the described one. In the stator 130, teeth 131 protruding toward the rotor 100 are provided along the inner surface of the stator 130. Windings 132 are provided on the teeth 131. The winding type of the windings 132 is not limited to concentrated winding, and may be distributed winding. The number of magnetic poles of the rotor 100 in the rotary machine 120 should be not less than two, that is, the number of rare earth sintered magnets 1 should be not less than two. Although the rotor 100 of the interior magnet type is adopted in FIG. 7, the surface magnet type may be adopted in which the rare earth sintered magnets 1 are fixed to the outer circumference with an adhesive.

As described above, the rotary machine 120 according to the fourth embodiment includes the rare earth sintered magnet 1 according to the first embodiment capable of improving magnetic properties at room temperature and reducing or preventing degradation of magnetic properties associated with temperature rise. Thus, because of the rare earth sintered magnet 1 capable of reducing or preventing degradation of magnetic properties associated with temperature rise while maintaining high residual magnetic flux density and coercive force, degradation of magnetic properties is reduced or prevented even in a high temperature environment exceeding 100° C. As a result, the rotor 100 can be stably driven and the operation of the rotary machine 120 can be stabilized even in a high temperature environment exceeding 100° C.

### EXAMPLES

Hereinafter, the rare earth sintered magnet 1 according to the present disclosure will be described in detail with reference to Examples and Comparative Examples.

In Examples 1 to 8 and Comparative Examples 1 to 6, the rare earth sintered magnet 1 is produced with the method described in the second embodiment using R-Fe-B-M-N-based samples of a plurality of rare earth magnet alloys 37 that differ in the composition of the main phase 10. The samples of Examples 1 to 8 and Comparative Examples 1 to 6 differ in the element R.

In Examples 1 to 8 and Comparative Examples 5 and 6, the rare earth sintered magnet 1 is produced using the rare earth magnet alloys 37 that differ in the content of Nd, La, and Sm in the element R. However, Examples 1 to 7 use the rare earth magnet alloy 37 containing no additive element N and additionally containing one or more elements M selected from the group consisting of Cu, Al, and Ga. Example 8 uses the rare earth magnet alloy 37 additionally containing the element M and one or more additive elements N selected from the group consisting of Co, Zr, Ti, Pr, Nb, Dy, Tb, Mn, Gd, and Ho.

Comparative Examples 1 and 3 use the rare earth magnet alloy 37 in which the element R is Nd. However, Comparative Example 1 does not contain the element M and the additive element N, and Comparative Example 3 does not contain the additive element N.

Comparative Examples 2 and 4 use the rare earth magnet alloy 37 in which the element R contains Nd and a heavy rare earth element Dy. However, Comparative Example 2 does not contain the element M and the additive element N, and Comparative Example 4 does not contain the additive element N.

Table 3 shows the general formulas of the rare earth sintered magnets according to Examples and Comparative Examples, the content of elements constituting the element R, the results of analysis of structure forms, and the results of determination of magnetic properties. Table 3 shows the general formula of the main phase 10 of each sample which is the rare earth sintered magnet 1 according to Examples 1 to 8 and Comparative Examples 1 to 6. Regarding the element M and the additive element N, Table 3 shows only whether they have been added or not. In Examples 1 to 8 and Comparative Examples 3 and 4, Cu, Al, and Ga are all contained as the element M.

TABLE 3

| | | Content (at %) | | | | Addition of | Addition of |
|---|---|---|---|---|---|---|---|
| | General formula | Nd | La | Sm | Dy | element M | additive element N |
| Comparative | Nd—Fe—B | 11.23 | — | — | — | Not added | Not added |
| Example 1 | | | | | | | |
| Comparative | (Nd,Dy)—Fe—B | 10.01 | — | — | 1.12 | Not added | Not added |
| Example 2 | | | | | | | |
| Comparative | Nd—Fe—B—M | 11.23 | — | — | — | Added | Not added |
| Example 3 | | | | | | | |
| Comparative | (Nd,Dy)—Fe—B—M | 10.01 | — | — | 1.12 | Added | Not added |
| Example 4 | | | | | | | |
| Comparative | (Nd,La,Sm)—Fe—B | 9.64 | 1.06 | 1.05 | — | Not added | Not added |
| Example 5 | | | | | | | |
| Comparative | (Nd,La,Sm)—Fe—B—N | 9.74 | 1.01 | 1.01 | — | Not added | Added |
| Example 6 | | | | | | | |
| Example 1 | (Nd,La,Sm)—Fe—B—M | 9.66 | 1.03 | 1.07 | — | Added | Not added |
| Example 2 | (Nd,La,Sm)—Fe—B—M | 11.64 | 0.51 | 0.45 | — | Added | Not added |
| Example 3 | (Nd,La,Sm)—Fe—B—M | 12.01 | 0.23 | 0.21 | — | Added | Not added |
| Example 4 | (Nd,La,Sm)—Fe—B—M | 13.30 | 0.05 | 0.04 | — | Added | Not added |
| Example 5 | (Nd,La,Sm)—Fe—B—M | 11.70 | 0.53 | 0.21 | — | Added | Not added |
| Example 6 | (Nd,La,Sm)—Fe—B—M | 11.74 | 0.23 | 0.52 | — | Added | Not added |
| Example 7 | (Nd,La,Sm)—Fe—B—M | 14.35 | 0.05 | 0.05 | — | Added | Not added |
| Example 8 | (Nd,La,Sm)—Fe—B—M—N | 14.20 | 0.11 | 0.12 | — | Added | Added |

| | | | Determination | | | |
|---|---|---|---|---|---|---|
| | Structure form | | | | Temperature | |
| | Concentration | Concentration | Residual | | coefficient | Temperature |
| | of Sm: | of element M: | magnetic | | of residual | coefficient |
| | first subphase > | First subphase < | flux | Coercive | magnetic | of coercive |
| | second subphase | second subphase | density | force | flux density | force |
| Comparative | X | X | — | — | — | — |
| Example 1 | | | | | | |
| Comparative | X | X | Poor | Good | Equivalent | Equivalent |
| Example 2 | | | | | | |
| Comparative | X | X | Equivalent | Good | Equivalent | Equivalent |
| Example 3 | | | | | | |
| Comparative | X | X | Poor | Good | Equivalent | Equivalent |
| Example 4 | | | | | | |
| Comparative | X | X | Poor | Poor | Good | Good |
| Example 5 | | | | | | |
| Comparative | X | X | Good | Equivalent | Good | Good |
| Example 6 | | | | | | |
| Example 1 | ◯ | ◯ | Good | Good | Good | Good |
| Example 2 | ◯ | ◯ | Good | Good | Good | Good |
| Example 3 | ◯ | ◯ | Good | Good | Good | Good |
| Example 4 | ◯ | ◯ | Good | Good | Good | Good |
| Example 5 | ◯ | ◯ | Good | Good | Good | Good |
| Example 6 | ◯ | ◯ | Good | Good | Good | Good |
| Example 7 | ◯ | ◯ | Good | Good | Good | Good |
| Example 8 | ◯ | ◯ | Good | Good | Good | Good |

Next, a method for analyzing the structure of the rare earth sintered magnet 1 according to Examples 1 to 8 and Comparative Examples 1 to 6 will be described. The structure form of the rare earth sintered magnet 1 is determined by elemental analysis using a scanning electron microscope (SEM) and an electron probe microanalyzer (EPMA). Here, a field emission electron probe microanalyzer (produced by JEOL Ltd., product name: JXA-8530F) is used as the SEM and the EPMA. Conditions for the elemental analysis are as follows: acceleration voltage: 15.0 kV, irradiation current: 22.71 nA, irradiation time: 130 ms, number of pixels: 512 pixels×512 pixels, magnification: 5000 times, number of integrations: one.

Next, a method for evaluating the magnetic properties of the rare earth sintered magnet 1 according to Examples 1 to 8 and Comparative Examples 1 to 6 will be described. The evaluation of the magnetic properties is performed by measuring the coercive force of a plurality of samples using a pulse excitation BH tracer. The maximum applied magnetic field obtained by the BH tracer is equal to or greater than 6 T, at which the rare earth sintered magnet 1 is completely magnetized. The pulse excitation BH tracer may be replaced with a direct current self-registering magnetometer also called a direct current BH tracer, a vibrating sample magnetometer (VSM), a magnetic property measurement system (MPMS), a physical property measurement system (PPMS), or the like, as long as a maximum applied magnetic field of 6T or more can be generated. The measurement is performed in an atmosphere containing an inert gas such as nitrogen. The magnetic properties of each sample are measured at a first measurement temperature T1 and a second measurement temperature T2 different from each other. The temperature coefficient α [%/° C.] of residual magnetic flux density is a value obtained by computing the ratio of the difference between the residual magnetic flux density at the first measurement temperature T1 and the residual magnetic flux density at the second measurement temperature T2 to the residual magnetic flux density at the first measurement temperature T1, and dividing the ratio by the difference in temperature (T2−T1). The temperature coefficient β [%/° C.] of coercive force is a value obtained by computing the ratio of the difference between the coercive force at the first measurement temperature T1 and the coercive force at the second measurement temperature T2 to the coercive force at the first measurement temperature T1, and dividing the ratio by the difference in temperature (T2−T1). Therefore, the smaller the absolute values |α| and |β| of the temperature coefficients of the magnetic properties, the more effectively degradation of the magnetic properties of the magnet with respect to temperature rise is reduced or prevented.

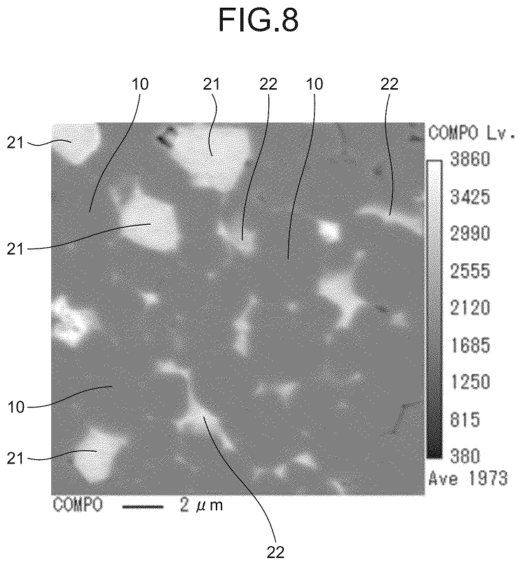

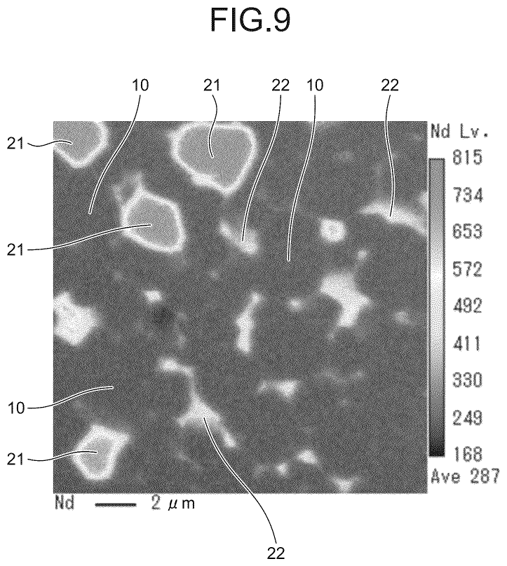

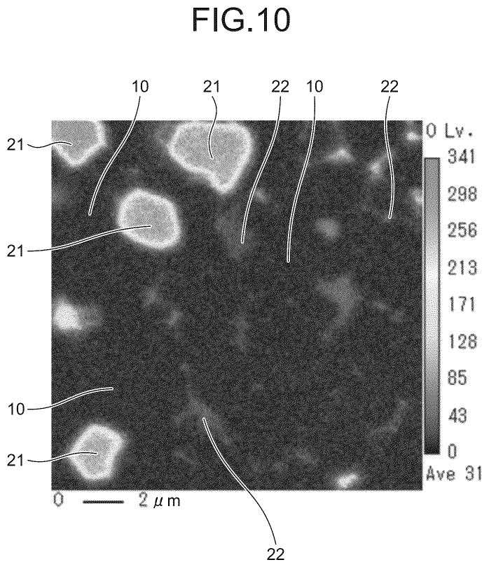

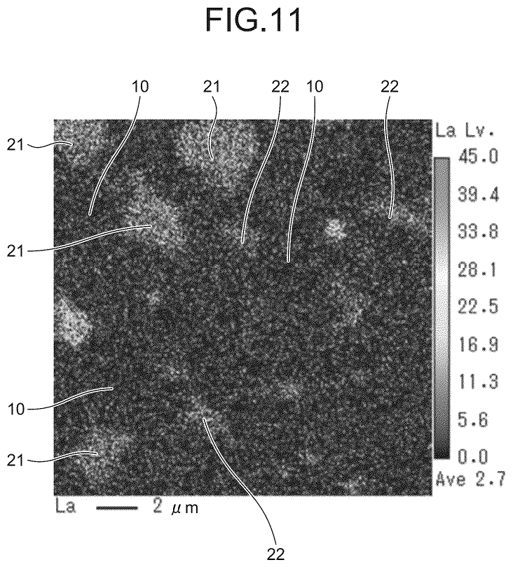

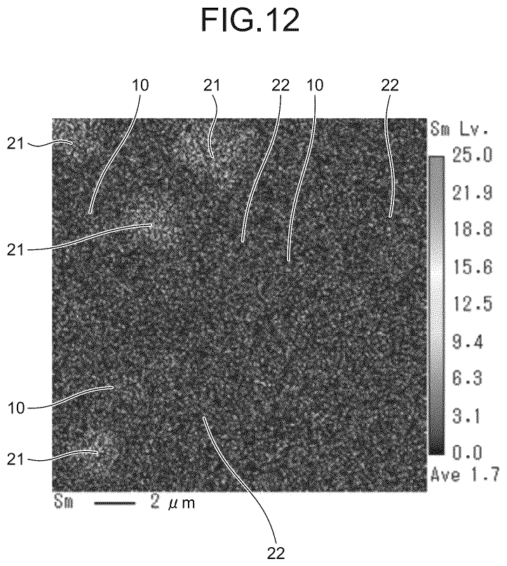

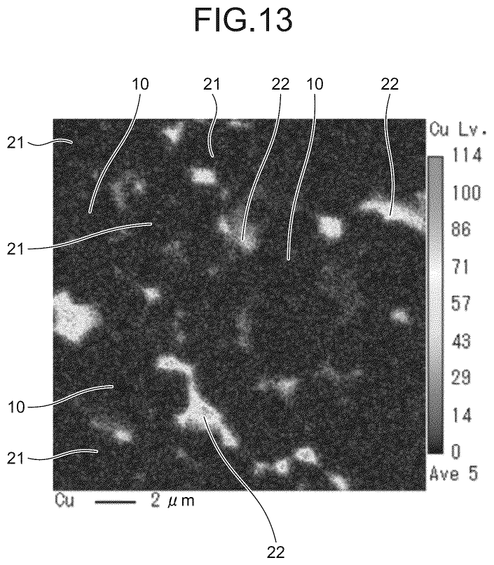

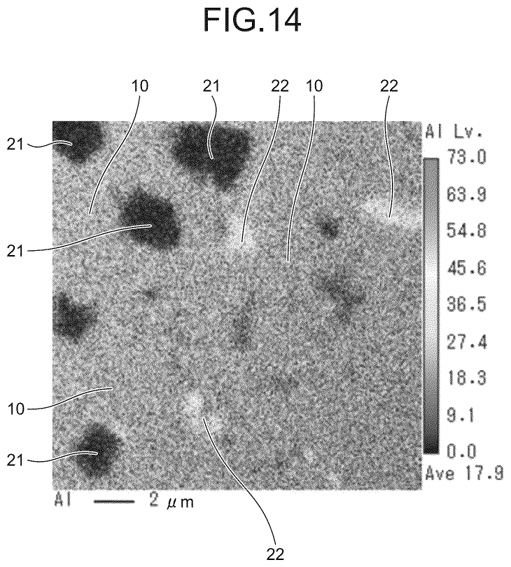

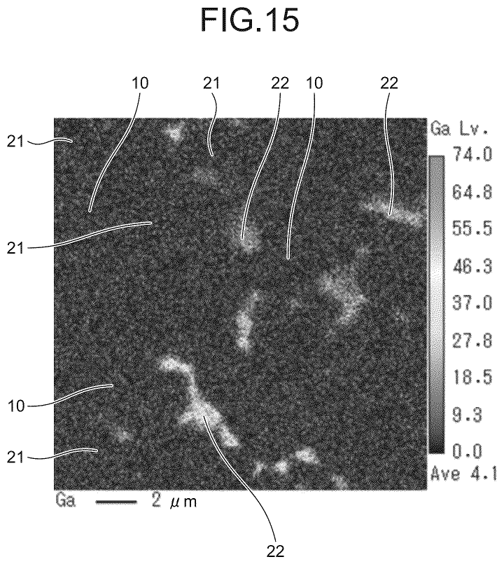

First, the results of analysis of the samples according to Examples 1 to 8 and Comparative Examples 1 to 6 will be described. FIG. 8 is a composition image obtained by analyzing a cross section of a rare earth sintered magnet according to Examples 1 to 8 with a field emission electron probe microanalyzer (FE-EPMA). FIGS. 9 to 15 are element maps obtained by analyzing a cross section of a rare earth sintered magnet according to Examples 1 to 8 with FE-EPMA. FIG. 9 is an element map of Nd, FIG. 10 is an element map of O, FIG. 11 is an element map of La, FIG. 12 is an element map of Sm, FIG. 13 is an element map of Cu, FIG. 14 is an element map of Al, and FIG. 15 is an element map of Ga. Note that FIGS. 9 to 15 are the element maps corresponding to the region illustrated in FIG. 8. Since the rare earth sintered magnets 1 according to Examples 1 to 8 all yield similar results, FIGS. 8 to 15 depict representative ones of Examples 1 to 8. Furthermore, components that are the same as those in FIG. 1 are denoted by the same reference signs.

It is confirmed from FIGS. 8 to 12 that each of the samples of Examples 1 to 8 contains the main phase 10 which is crystal grains based on an R₂Fe₁₄B crystal structure, the crystalline first subphase 21 mainly composed of an oxide phase represented by (Nd, La, Sm)—O, and the crystalline second subphase 22 mainly composed of an oxide phase represented by (Nd, La)—O. In addition, it is confirmed from FIG. 12 that in each of the samples of Examples 1 to 8, the concentration of Sm is higher in the first subphase 21 than in the second subphase 22. It is confirmed from FIGS. 13 to 15 that the concentration of one or more elements M selected from the group consisting of Cu, Al, and Ga is higher in the second subphase 22 than in the first subphase 21.

In Table 3, the state in which the concentration of Sm is higher in the first subphase 21 than in the second subphase 22 is indicated in the item “concentration of Sm: first subphase>second subphase” in structure form, and the state in which the concentration of the element M is higher in the second subphase 22 than in the first subphase 21 is indicated in the item “concentration of element M: first subphase<second subphase” in structure form. Among Examples 1 to 8 and Comparative Examples 1 to 6, samples in which these states were confirmed are indicated by “o”, and samples in which these states were not be confirmed are indicated by “x”.

In addition, it is confirmed from the intensity ratio of the element maps obtained with the FE-EPMA analysis that the sum of the concentrations of La in the first subphase 21 and the second subphase 22 is equal to or greater than the concentration of La in the main phase 10, and the sum of the concentrations of Sm in the first subphase 21 and the second subphase 22 is equal to or greater than the concentration of Sm in the main phase 10. Furthermore, it is confirmed that the concentration of La in the first subphase 21 is equal to or higher than the concentration of La in the second subphase 22.

Here, from the intensity ratio of the element maps obtained through FE-EPMA analysis of the concentration of La contained in the main phase 10, the first subphase 21, and the second subphase 22 and the concentration of Sm contained in the main phase 10, the first subphase 21, and the second subphase 22, it is confirmed that the relationship between the concentration of La contained in the main phase 10, the first subphase 21, and the second subphase 22 and the concentration of Sm contained in the main phase 10, the first subphase 21, and the second subphase 22 satisfies Formula (1) above.

Next, the results of measurement of the magnetic properties in each sample according to Examples 1 to 8 and Comparative Examples 1 to 6 will be described. The shape of each sample that is the subject of magnetic measurement is a block shape having a length, a width, and a height of 7 mm. The first measurement temperature T1 is 23° C., and the second measurement temperature T2 is 200° C. 23° C. is room temperature. 200° C. is a temperature that can occur as an environment in which automobile motors and industrial motors operate.

First, the residual magnetic flux density and the coercive force in each sample according to Examples 1 to 8 and Comparative Examples 2 to 6 are determined in comparison with Comparative Example 1. When the values of the residual magnetic flux density and the coercive force of each sample at 23° C. are within an allowable measurement error of 1% compared with the values of Comparative Example 1, the values are rated as “equivalent”. Values of 1% or more higher are rated as “good”, and values of 1% or more lower are rated as “poor”.

Next, the temperature coefficient α of residual magnetic flux density is calculated using the residual magnetic flux density at the first measurement temperature T1 of 23° C. and the residual magnetic flux density at the second measurement temperature T2 of 200° C. The temperature coefficient β of coercive force is calculated using the coercive force at the first measurement temperature T1 of 23° C. and the coercive force at the second measurement temperature T2 of 200° C. The temperature coefficient of residual magnetic flux density and the temperature coefficient of coercive force in each sample according to Examples 1 to 8 and Comparative Examples 2 to 6 are determined in comparison with Comparative Example 1. When the values of each sample are within an allowable measurement error of ±1% compared with the absolute value |α| of the temperature coefficient of residual magnetic flux density and the absolute value |β| of the temperature coefficient of coercive force in the sample of Comparative Example 1, the values are rated as “equivalent”. Values of −1% or more lower are rated as “good”, and values of +1% or more higher are rated as “poor”. Because the samples determined to be “good” have a smaller temperature coefficient, it is possible to provide the rare earth sintered magnet 1 having stable magnetic properties even in a high temperature environment while reducing or preventing degradation of magnetic properties associated with temperature rise.

The results of determination of the residual magnetic flux density, the coercive force, the temperature coefficient of residual magnetic flux density, and the temperature coefficient of coercive force are shown in Table 3.

Comparative Example 1 is a sample of the rare earth sintered magnet 1 prepared in the form of Nd—Fe—B with the production method according to the second embodiment using Nd, Fe, and FeB as raw materials. From the observation of the structure form of this sample according to the above-described method, due to the absence of Sm, it is not confirmed that the concentration of Sm is higher in the first subphase 21 than in the second subphase 22. Furthermore, due to the absence of the element M, it is not confirmed that the concentration of the element M is higher in the second subphase 22 than in the first subphase 21. The evaluation of the magnetic properties of this sample with the method described above shows that the residual magnetic flux density is 1.3 T and the coercive force is 1000 kA/m. The temperature coefficients of residual magnetic flux density and coercive force are |α|=0.191%/° C. and |β|=0.460%/° C., respectively. These values of Comparative Example 1 are used as a reference.

Comparative Example 2 is a sample of the rare earth sintered magnet 1 prepared in the form of (Nd, Dy)—Fe—B with the production method according to the second embodiment using Nd, Dy, Fe, and FeB as raw materials. From the observation of the structure form of this sample according to the above-described method, due to the absence of Sm, it is not confirmed that the concentration of Sm is higher in the first subphase 21 than in the second subphase 22. Furthermore, due to the absence of the element M, it is not confirmed that the concentration of the element M is higher in the second subphase 22 than in the first subphase 21. The evaluation of the magnetic properties of this sample with the method described above shows that the residual magnetic flux density is “poor”, the coercive force is “good”, the temperature coefficient of residual magnetic flux density is “equivalent”, and the temperature coefficient of coercive force is “equivalent”. This result indicates that the coercive force is improved by substituting Dy having high magnetocrystalline anisotropy for a part of Nd.

Comparative Example 3 is a sample of the rare earth sintered magnet 1 prepared in the form of Nd—Fe—B-M with the production method according to the second embodiment using Nd, Fe, FeB, and further the element M as raw materials. From the observation of the structure form of this sample according to the above-described method, due to the absence of Sm, it is not confirmed that the concentration of Sm is higher in the first subphase 21 than in the second subphase 22. In addition, despite the addition of the element M, the first subphase 21 and the second subphase 22 are not formed due to the absence of Sm, and it is not confirmed that the concentration of the element M is higher in the second subphase 22 than in the first subphase 21. The evaluation of the magnetic properties of this sample with the method described above shows that the residual magnetic flux density is “equivalent”, the coercive force is “good”, the temperature coefficient of residual magnetic flux density is “equivalent”, and the temperature coefficient of coercive force is “equivalent”. This result reflects the fact that the crystal grain boundary is made non-magnetic by the element M, and the coercive force is improved, but the concentration of Sm and the concentration of the element M in the subphase 20 do not accord with an appropriate structure form due to the absence of La and Sm.

Comparative Example 4 is a sample of the rare earth sintered magnet 1 prepared in the form of (Nd, Dy)—Fe—B-M with the production method according to the second embodiment using Nd, Dy, Fe, FeB, and further the element M as raw materials. From the observation of the structure form of this sample according to the above-described method, due to the absence of Sm, it is not confirmed that the concentration of Sm is higher in the first subphase 21 than in the second subphase 22. In addition, despite the addition of the element M, the first subphase 21 and the second subphase 22 are not formed due to the absence of Sm, and it is not confirmed that the concentration of the element M is higher in the second subphase 22 than in the first subphase 21. The evaluation of the magnetic properties of this sample with the method described above shows that the residual magnetic flux density is “poor”, the coercive force is “good”, the temperature coefficient of residual magnetic flux density is “equivalent”, and the temperature coefficient of coercive force is “equivalent”. This result reflects the fact that a part of Nd is replaced by Dy having high magnetocrystalline anisotropy, and the crystal grain boundary is made non-magnetic by M, whereby the coercive force is improved, but the concentration of Sm and the concentration of the element M in the subphase 20 do not accord with an appropriate structure form due to the absence of La and Sm.

Comparative Example 5 is a sample of the rare earth sintered magnet 1 prepared in the form of (Nd, La, Sm)—Fe—B with the production method according to the second embodiment using Nd, La, Sm, Fe, and FeB as raw materials. From the observation of the structure form of this sample according to the above-described method, the two types of subphases 20, namely the first subphase 21 and the second subphase 22, are not confirmed due to the absence of M despite the addition of Sm, and the concentration of Sm is uniformly dispersed in the main phase 10 and the subphase 20. Furthermore, because the two types of subphases 20 are not present, it is not confirmed that the first subphase 21 is higher than the second subphase 22. Furthermore, due to the absence of the element M, it is not confirmed that the concentration of the element M is higher in the second subphase 22 than in the first subphase 21. The evaluation of the magnetic properties of this sample with the method described above shows that the residual magnetic flux density is “poor”, the coercive force is “poor”, the temperature coefficient of residual magnetic flux density is “good”, and the temperature coefficient of coercive force is “good”. This result reflects the fact that the presence of La and Sm in the main phase 10 or the subphase 20 gives a good result in the temperature coefficient of the magnetic properties, but the two types of subphases 20 are not present, and the concentration of Sm and the concentration of the element M in these subphases 20 do not accord with an appropriate structure form.

Comparative Example 6 is a sample of the rare earth sintered magnet 1 prepared in the form of (Nd, La, Sm)—Fe—B—N with the production method according to the second embodiment using Nd, La, Sm, Fe, and FeB, and further one or more additive elements N selected from the group consisting of Co, Zr, Ti, Pr, Nb, Dy, Tb, Mn, Gd, and Ho as raw materials. From the observation of the structure form of this sample according to the above-described method, the two types of subphases 20, namely the first subphase 21 and the second subphase 22, are not confirmed due to the absence of the element M despite the addition of Sm, and the concentration of Sm is uniformly dispersed in the main phase 10 and the subphase 20. Furthermore, because the two types of subphases 20 are not present, it is not confirmed that the first subphase 21 is higher than the second subphase 22. Furthermore, due to the absence of the element M, it is not confirmed that the concentration of the element M is higher in the second subphase 22 than in the first subphase 21. The evaluation of the magnetic properties of this sample with the method described above shows that the residual magnetic flux density is “good”, the coercive force is “poor”, the temperature coefficient of residual magnetic flux density is “good”, and the temperature coefficient of coercive force is “good”. The presence of La and Sm in the main phase 10 or the subphase 20 gives a good result in the temperature coefficient of the magnetic properties. In addition, the magnetic flux density is improved by the effect of the additive element N such as Co, which is a magnetic material. However, the result reflects the fact that the two types of subphases 20 are not present, and the concentration of Sm and the concentration of the element M in these subphases 20 do not accord with an appropriate structure form.

Examples 1 to 7 are samples of the rare earth sintered magnet 1 prepared in the form of (Nd, La, Sm)—Fe—B—M with the production method according to the second embodiment using Nd, La, Sm, Fe, FeB, and further the element M as raw materials. From the observation of the structure form of these samples according to the above-described method, it is confirmed that the concentration of Sm is higher in the first subphase 21 than in the second subphase 22. Furthermore, it is confirmed that the concentration of the element M is higher in the second subphase 22 than in the first subphase 21. The evaluation of the magnetic properties of these samples with the method described above shows that the residual magnetic flux density is “good”, the coercive force is “good”, the temperature coefficient of residual magnetic flux density is “good”, and the temperature coefficient of coercive force is “good”.

Example 8 is a sample of the rare earth sintered magnet 1 prepared in the form of (Nd, La, Sm)—Fe—B-M with the production method according to the second embodiment using Nd, La, Sm, Fe, FeB, the element M, and further the additive element N as raw materials. From the observation of the structure form of this sample according to the above-described method, it is confirmed that the concentration of Sm is higher in the first subphase 21 than in the second subphase 22. Furthermore, it is confirmed that the concentration of the element M is higher in the second subphase 22 than in the first subphase 21. The evaluation of the magnetic properties of these samples with the method described above shows that the residual magnetic flux density is “good”, the coercive force is “good”, the temperature coefficient of residual magnetic flux density is “good”, and the temperature property evaluation of coercive force is “good”. This indicates that the obtained effect is not influenced by the addition of the additive element N as long as a proper structure form is formed. The samples of Examples 1 to 8 are the rare earth sintered magnets 1 satisfying the general formula (Nd, La, Sm)—Fe—B-M and including: the main phase 10 including crystal grains based on an R₂Fe₁₄B crystal structure; the first subphase 21 that is crystalline and mainly composed of an oxide phase represented by (Nd, La, Sm)—O; and the second subphase 22 that is crystalline and mainly composed of an oxide phase represented by (Nd, La)—O. As described above, in the rare earth sintered magnets 1 according to Examples 1 to 8, the concentration of Sm is higher in the first subphase 21 than in the second subphase 22, and the concentration of the element M is higher in the second subphase 22 than in the first subphase 21. As a result, these rare earth sintered magnets 1 are capable of improving magnetic properties at room temperature and reducing or preventing degradation of magnetic properties associated with temperature rise with reduced use of Nd and heavy rare earth elements, which are expensive and have a procurement risk due to high distribution unevenness, compared with the rare earth sintered magnet satisfying Nd—Fe—B.

The configurations described in the above-mentioned embodiments indicate examples. The embodiments can be combined with another well-known technique and with each other, and some of the configurations can be omitted or changed in a range not departing from the gist.

### REFERENCE SIGNS LIST

1 rare earth sintered magnet; 10 main phase; 20 subphase; 21 first subphase; 22 second subphase; 31 crucible; 32 molten alloy; 33 tundish; 34 single roll; 35 solidified alloy; 36 tray container; 37 rare earth magnet alloy; 100 rotor core; 102 magnet insertion hole; 120 rotary machine; 130 stator; 131 teeth; 132 winding.

1. A rare earth sintered magnet satisfying a general formula (Nd, La, Sm)—Fe—B-M, where element M is one or more elements selected from a group consisting of Cu, Al, and Ga, the rare earth sintered magnet comprising:
a main phase including crystal grains based on an R₂Fe₁₄B crystal structure;
a first subphase that is crystalline and mainly composed of an oxide phase represented by (Nd, La, Sm)—O; and
a second subphase that is crystalline and mainly composed of an oxide phase represented by (Nd, La)—O, wherein
a concentration of Sm segregated in a crystalline subphase consisting of the first subphase and the second subphase is higher than a concentration of Sm in the main phase,
a concentration of Sm is higher in the first subphase than in the second subphase, and
a concentration of the element M is higher in the second subphase than in the first subphase.

2. The rare earth sintered magnet according to claim 1, wherein
a sum of concentrations of La in the first subphase and the second subphase is equal to or greater than a concentration of La in the main phase, and
a sum of concentrations of Sm in the first subphase and the second subphase is equal to or greater than a concentration of Sm in the main phase.

3. The rare earth sintered magnet according to claim 1, wherein a concentration of La in the first subphase is equal to or higher than a concentration of La in the second subphase.

4. The rare earth sintered magnet according to claim 1, wherein a>(b+c) is satisfied, where a, b, and c represent composition ratios of Nd, La, and Sm, respectively.

5. The rare earth sintered magnet according to claim 1, wherein 1<(Y₁+Y₂)/Y<(X₁+X₂)/X is satisfied, where X represents the concentration of La contained in the main phase, X₁ represents the concentration of La contained in the first subphase, X₂ represents the concentration of La contained in the second subphase, Y represents the concentration of Sm contained in the main phase, Y₁ represents the concentration of Sm contained in the first subphase, and Y₂ represents the concentration of Sm contained in the second subphase.

6. The rare earth sintered magnet according to claim 1, further comprising: one or more additive elements N selected from a group consisting of Co, Zr, Ti, Pr, Nb, Dy, Tb, Mn, Gd, and Ho.

7. A method for producing the rare earth sintered magnet according to claim 1, the method comprising:
a melting of melting a raw material of a rare earth magnet alloy containing an element constituting the rare earth sintered magnet;
a primary cooling of cooling the raw material molten in the melting to obtain a solidified alloy;
a secondary cooling of further cooling the solidified alloy to obtain a rare earth magnet alloy;
a pulverizing of pulverizing the rare earth magnet alloy satisfying (Nd, La, Sm)—Fe—B-M to obtain powder of rare earth magnet alloy;
a molding of preparing a molded body by molding powder of the rare earth magnet alloy;
a sintering of preparing a sintered body by holding the molded body at a sintering temperature in a range of 900° C. to 1300° C. for a period of time in a range of 0.1 hours to 10 hours;
a primary aging of holding the sintered body at a primary aging temperature of 700° C. or higher but lower than 900° C. that is a temperature lower than the sintering temperature for 0.1 hours to 10 hours;
a secondary aging of holding the sintered body held in the primary aging at a secondary aging temperature of 450° C. or higher but lower than 700° C. that is a temperature lower than the primary aging temperature for 0.1 hours to 10 hours; and
a cooling of holding the sintered body held in the secondary aging at a temperature of 200° C. or higher but lower than 450° C. that is a temperature lower than the secondary aging temperature for 0.1 hours to 5 hours.

8-10. (canceled)

11. A rotor comprising:
a rotor core; and
the rare earth sintered magnet according to claim 1 provided in the rotor core.

12. A rotary machine comprising:
the rotor according to claim 11; and
an annular stator facing the rotor and including, on an inner surface on a side where the rotor is placed, teeth protruding toward the rotor and windings provided on the teeth.
